(19) United States
(12) Patent Application Publication
(10) Pub. No.: US 2009/0100521 A1
(43) Pub. Date: Apr. 16, 2009

(54) MALICIOUS SOFTWARE PREVENTION APPARATUS, SYSTEM, AND METHOD USING SAME

(75) Inventors: PIN-FENG FU, Shenzhen (CN); SHIH-FANG WONG, Tu-Cheng (TW); ZHAN-WU LI, Shenzhen (CN); CHUN-HUA LI, Shenzhen (CN)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,107

(22) Filed: Dec. 29, 2007

(30) Foreign Application Priority Data
Oct. 15, 2007 (CN) 200710202064.X

(51) Int. Cl. G06F 21/00

(52) U.S. Cl. 726/24

(57) ABSTRACT

A malicious software prevention method is used for detecting malicious software and includes receiving data transmitted from a host machine or a mobile terminal and temporally storing the received data as temporary data in a random access memory; detecting malicious software by scanning the temporary data with malicious data definitions stored in a read only memory; cutting off a data connection between the host machine and the malicious software prevention apparatus or between the mobile terminal and the malicious software prevention apparatus if the malicious software is detected in the temporary data.

### BACKGROUND

1. Field of the Invention

The present invention generally relates to malicious software prevention apparatuses, malicious software prevention systems, and particularly, to a malicious software prevention apparatus, a malicious software prevention system, and a malicious software prevention method using the same.

2. Description of Related Art

Malicious software (often shortened as malware) is a software designed to infiltrate or damage a computer system without an owner's informed consent. The best-known types of malicious software are viruses and worms. The viruses require user intervention to spread, whereas the worms spread automatically.

Mobile terminals, for example, mobile phone, personal digital assistant (PDA) may be infected by the malicious software by downloading files or software applications containing the malicious software from a computer.

Conventionally, in order to protect a mobile terminal and the computer, the mobile terminal is connect to, from infecting each other, a malicious prevention software, for example, may be installed on the computer for monitoring both the computer and the mobile terminal. However, if the mobile terminal is not connected to the computer and the user wants to check whether the mobile terminal is infected by malicious software or has malicious software contained therein, the user needs to turn on the computer, launch the malicious software prevention software, and connect the mobile terminal to the computer.

Therefore, what is needed in the industry is to provide a simple malicious software prevention method for detecting if the mobile terminal is infected by the malicious software or has the malicious software contained therein. Moreover, a malicious software prevention system, and a malicious software prevention apparatus are provided for implementing the malicious software prevention method.

### SUMMARY

Accordingly, a malicious software prevention method is provided. The malicious software prevention method is used for detecting malicious software and includes receiving data transferred from a host machine or a mobile terminal and temporally storing the data as temporary data in a random access memory of a malicious software prevention apparatus; detecting malicious software by scanning the temporary data with malicious data definitions stored in a read only memory; cutting off a data connection between the host machine and the malicious software prevention apparatus or a data connection between the mobile terminal and the malicious software prevention apparatus if malicious software is detected in the temporary data. Moreover, a malicious software prevention system and a malicious software prevention apparatus for implementing the malicious software prevention method are provided.

### BRIEF DESCRIPTION OF THE DRAWINGS

FIG. 1 illustrates a block diagram of a malicious software prevention system comprising a malicious software prevention apparatus.

FIG. 2 illustrates a detailed block diagram of the malicious software prevention apparatus in FIG. 1.

FIG. 3 illustrates a flow chart of a malicious software prevention method using the malicious software prevention system and malicious software prevention apparatus in FIG. 1 and FIG. 2.

### DETAILED DESCRIPTION

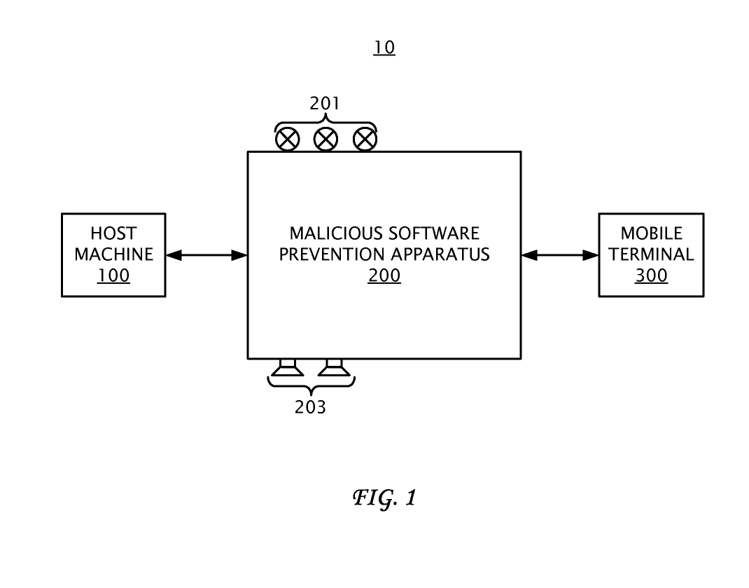

Referring to FIG. 1, a malicious software prevention system 10 is provided for implementing a malicious software prevention method. The malicious software prevention system 10 includes a host machine 100, a malicious software prevention apparatus 200, and a mobile terminal 300. The malicious software prevention apparatus 200 is coupled between the host machine 100 and the mobile terminal 300. The host machine 100 may be a desktop personal computer, a notebook computer, or a server. The mobile terminal 300 may be a mobile phone, a personal digital assistant (PDA), a mobile hard disk, or a semiconductor storage device such as a flash read only memory (Flash ROM).

The malicious software prevention apparatus 200 is configured for monitoring the mobile terminal 300 and detecting/scanning if malicious software is contained in the host machine 100 or in the mobile terminal 300. When no malicious software is found, the malicious software prevention apparatus 200 allows data and files to be transferred between the host machine 100 and the mobile terminal 300. When malicious software is found, the malicious software prevention apparatus 200 may use different ways to identify, thwart, and eliminate the malicious software. For example, a data transfer path or a data connection between the host machine 100 and the mobile terminal 300 is discontinued. Thus, malicious software cannot infect the mobile terminal 300 through the host computer 100, and vice versa.

Indicators such as lamps 201 or speakers 203 may be used as visual and audible aids with the malicious software prevention apparatus 200. When malicious software is detected, the lamps 201 may output a predetermined pattern of light flashes and the speakers 203 may output buzzing sounds to alert a user that malicious software is detected.

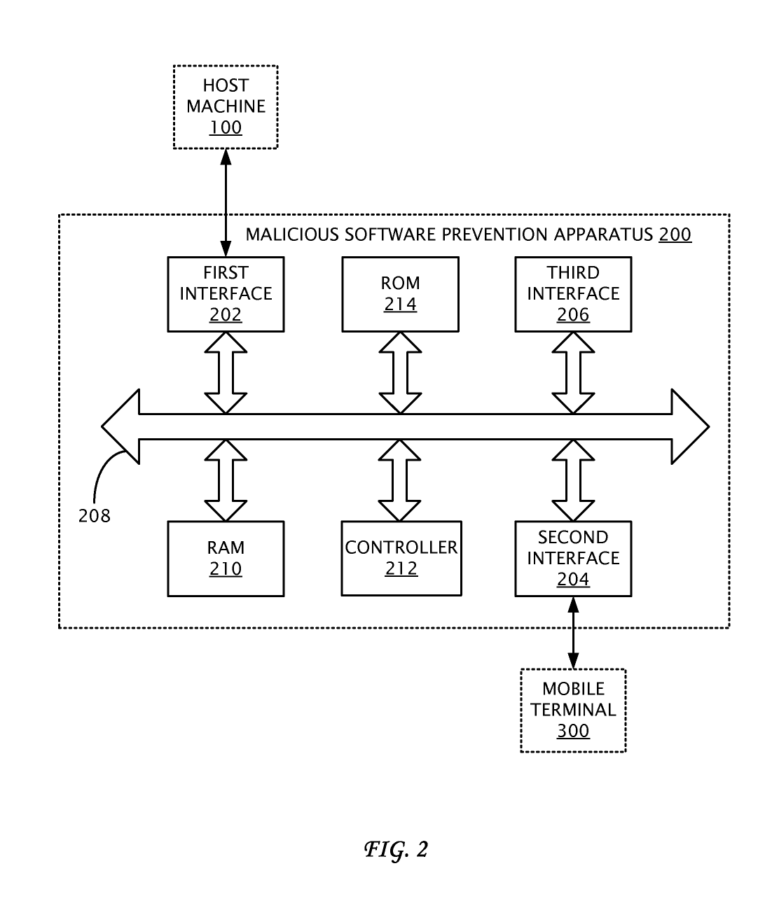

Referring to FIG. 2, a block diagram of the malicious software prevention apparatus 200 includes a controller 212, a random access memory (RAM) 210, a read only memory (ROM) 214, a first interface 202, a second interface 204, and a third interface 206 that are connected to each other over a data bus 208.

The first interface 202 is connected to the host machine 100 for receiving data from or transferring data to the host machine 100. The second interface 204 is connected to the mobile terminal 300 for transferring data to or receiving data from the mobile terminal 300.

The controller 212 may be an application specific integrated circuit (ASIC) or a digital signal processor (DSP) directed to a specific function for monitoring and detecting malicious software. The controller 212 is configured for controlling data to be transferred and program to be executed. The RAM 210 is configured for temporarily storing the data as temporary data received by the first interface 202 or the second interface 204. The ROM 214 is configured for storing malicious software definitions for identifying malicious software. The definitions are used to identify if malicious software is contained in the temporary data. The definitions can be updated to a new definition version by connecting the third interface 206 to a malicious definition library such as a personal computer malicious definition library or a server malicious definition library.

The mobile terminal 300 is connected to the malicious software prevention apparatus 200 via the second interface 204 for detecting malicious software. The file stored in the mobile terminal 300 is transferred to and temporally stored in the RAM 210 as the temporary data by the controller 211. The controller 212 retrieves the malicious software definitions stored in the ROM 214. The temporary data in the RAM 210 is scanned for known malicious software definitions.

If a piece of code of the temporary data matches with any identified malicious software definitions, then the malicious software prevention apparatus 200 can perform certain actions such as the following: First, have the temporary data cleaned/fixed/disinfected by removing the malicious software from the temporary data. Second, have the temporary data quarantined such that the temporary data becomes inaccessible to other programs and the malicious software can no longer spread. Third, delete the temporary data from the RAM 210. Furthermore, if the malicious software is detected, the controller 212 sends out an indication message by means of lamps outputting a predetermined pattern of light flashes, or by means of speaker outputting buzzing sounds.

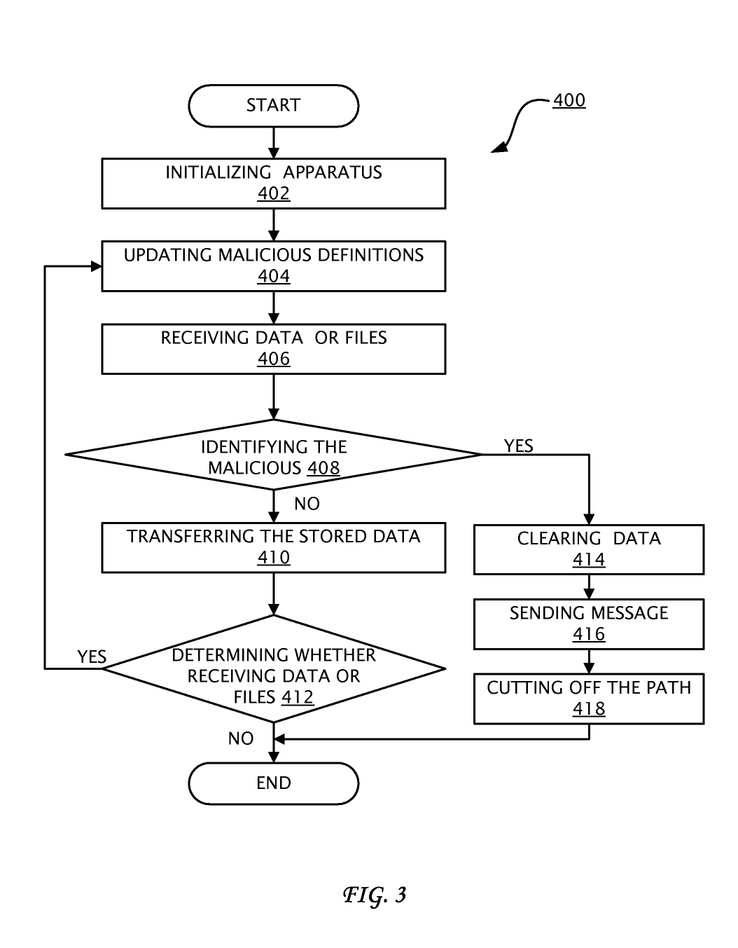

Referring to FIG. 3, a malicious software prevention method 400 using the malicious software prevention system 10 and the malicious software prevention apparatus 200 will be described. For example, the method 400 may be performed when a software application is downloaded from the host machine 100 to the mobile machine 300.

At block 402, the process starts and initializes the malicious software prevention apparatus 200.

At block 404, the malicious software definitions are updated to new versions. For example, the malicious software prevention apparatus 200 is connected to a server malicious definition library. The newest version of malicious software definitions are obtained from a server malicious library. The newest version of malicious software definitions are updated to add new identified malicious software definitions that are stored in the ROM 214.

At block 406, data or files are received. For example, a software application to be downloaded is transferred from the host machine 100 via the first interface 202. The received data is stored in the RAM 210 as temporary data under the control of the controller 212.

At block 408, the malicious software is detected. For example, the received data stored in the RAM 210 is scanned by referring to the malicious definitions stored in the ROM 214 under control of the controller 212. If a piece of code of the temporary data matches with any identified malicious software definitions, the temporary data may be repaired, or quarantined, or deleted.

At block 410, if the received data scanned does not contain malicious software, the received data is transferred. For example, the temporary data stored in the RAM 210 is transferred to the mobile terminal 300 via the data bus 208 and the second interface 204.

At block 412, if other data or files needs to be downloaded is determined. For example, an instruction is issued to the malicious software prevention apparatus 200 from the host machine 100 if another software application needs to be downloaded to the mobile terminal 300. If another software application is downloaded, the procedure loops back to the block 404 to update the malicious software definitions. If no other data is determined to be downloaded, the procedure goes to end directly.

At block 414, if the received data is confirmed to contain malicious software, the received data is repaired, or quarantined, or deleted. For example, the controller 212 issues a reset instruction to the RAM 210. As a result, the temporary data stored in the RAM 210 is cleared.

At block 416, if the received data is confirmed to contain malicious software, an indicating message is sent. For example, the controller 212 sends an indicating message to the host machine 100 via the data bus 208 and the first interface 202. The user is alerted that the software application may contain malicious software. Other means such as a pattern of flashes light outputted by lamps or buzzing sounds outputted from speakers may be used as “indicating message” for altering the user the malicious software is threatening.

At block 418, the transferring path is discontinued. For example, the controller 212 cuts off the transferring path between the second interface 204 and the mobile terminal 300. The mobile terminal 300 is protected from being infected by malicious software. The procedure then goes to end directly.

Similarly, a file or a software application may be transferred or uploaded from the mobile terminal 300 to the host machine 100. The malicious software prevention method 400 is performed by cutting off the transferring path or data connection between the host machine 100 and the malicious software prevention apparatus 200 for the malicious software is detected. Correspondingly, the malicious software can be detected and eliminated by clearing the received data temporally stored in the RAM 210 of the malicious software prevention apparatus 200.

As the embodiment disclosed above, the malicious software prevention apparatus 200 can be used for detecting malicious software without directly connecting the mobile terminal 300 to the host machine 100 such as a personal computer. The malicious software prevention method 400 is simple for checking malicious software contained in the mobile terminal 300. When the host machine 100 and the mobile terminal 300 transfers data or files with each other, the malicious software is easily detected and eliminated by the malicious software prevention apparatus 200 of the malicious software prevention system 10.

Alternative embodiments will become apparent to those skilled in the art to which the present invention pertains without departing from its spirit and scope. For example, the first interface 202, the second interface 204, and the third interface 206 may be wireless interface such as Wi-Fi®, Bluetooth®, infrared and so on.

What is claimed is:

1. A malicious software prevention apparatus for detecting malicious software, comprising:
a controller;
a first interface connected to a host machine;
a second interface connected to a mobile terminal;
a random access memory for storing temporary data sent from the host machine through the first interface, or from the mobile terminal through the second interface; and
a read only memory storing malicious software definitions, the temporary data stored in the random access memory being scanned and compared to the malicious software definitions, under the control of the controller, to identify if any of the malicious software definitions matches any of the temporary data in the random access memory in order to prevent the host machine and the mobile terminal from infecting with each other.

2. The malicious software prevention apparatus as claimed in claim 1, wherein if malicious software is not detected in the temporary data, the temporary data is sent to the mobile terminal through the second interface, or to the host machine through the first interface.

3. The malicious software prevention apparatus as claimed in claim 1, wherein if malicious software is not detected in the temporary data, a first data connection between the host machine and the first interface is discontinued, or a second data connection between the mobile terminal and the second interface is discontinued.

4. The malicious software prevention apparatus as claimed in claim 1, wherein the malicious software prevention apparatus sends an indicating message to the host machine, when the data to be downloaded from the host machine to the mobile terminal contains malicious software.

5. The malicious software prevention apparatus as claimed in claim 1, wherein the malicious software prevention apparatus further comprises,
a plurality of lamps, the plurality of lamps outputting a predetermined pattern of light flashes if the malicious software is detected in the temporary data.

6. The malicious software prevention apparatus as claimed in claim 1, wherein the malicious software prevention apparatus further comprises,
a speaker, the speaker outputting sounds if the malicious software is detected in the temporary data.

7. The malicious software prevention apparatus as claimed in claim 1, wherein the malicious software prevention apparatus further comprises,
a third interface, the third interface receiving new versions of malicious software definitions, the new versions of malicious software definitions are stored in the read only memory to replace original malicious software definitions.

8. The malicious software prevention apparatus as claimed in claim 1, wherein the mobile terminal is selected from a mobile phone, a personal digital assistant, or a semiconductor data storage device.

9. A malicious software prevention system for identifying malicious, comprising:
a host machine;
a mobile terminal; and
a malicious software prevention apparatus coupled between the host machine and the mobile terminal for detecting if data transferred between the host machine and the mobile terminal contains malicious software.

10. The malicious software prevention system as claimed in claim 9, wherein the malicious software prevention apparatus comprises:
a controller;
a first interface connected to a host machine;
a second interface connected to a mobile terminal;
a random access memory for storing temporary data sent from the host machine through the first interface, or from the mobile terminal through the second interface; and
a read only memory storing malicious software definitions, the temporary data stored in the random access memory being and compared to the malicious software definitions, under the control of the controller, to identify if any of the malicious software definitions matches any of the temporary data in the random access memory in order to prevent the host machine and the mobile terminal from infecting with each other.

11. The malicious software prevention system as claimed in claim 10, wherein the malicious software prevention apparatus further comprises,
a third interface receiving a new version of malicious software definitions, the new version of malicious software definitions are stored in the read only memory to replace original malicious software definitions.

12. The malicious software prevention system as claimed in claim 10, wherein the malicious software prevention apparatus further comprises,
a plurality of lamps, the plurality of lamps outputting a predetermined pattern of light flashes if the malicious software is detected in the temporary data.

13. The malicious software prevention system as claimed in claim 10, wherein the malicious software prevention apparatus further comprises
a speaker, the speaker outputting sounds if the malicious software is detected in the temporary data.

14. The malicious software prevention system as claimed in claim 13, wherein the first interface and the second interface use wireless means for coupling the host machine and the mobile terminal thereto respectively.

15. A malicious software prevention method for identifying malicious, comprising:
receiving data transmitted from a host machine or a mobile terminal and temporally storing the received data as temporary data in a random access memory of the malicious software prevention apparatus;
detecting malicious software by retrieving malicious software definitions stored in a read only memory of the malicious software prevention apparatus and scanning the temporary data stored in the random access memory to identify if any of the malicious software definitions is matched in order to prevent the host machine and the mobile terminal from infecting with each other;
cutting off a first data connection between the host machine and the malicious software prevention apparatus or cutting off a second data connection between the mobile terminal and the malicious software prevention apparatus if malicious software is detected in the temporary data.

16. The malicious software prevention method as claimed in claim 15, further comprising:
transferring the temporary data stored in the random access memory to the host machine, or to the mobile terminal under control of a controller of the malicious software prevention apparatus, if the malicious software is detected in the temporary data.

17. The malicious software prevention method as claimed in claim 15, further comprising:
updating the malicious data connection definitions stored in the read only memory to a new version.

18. The malicious software prevention method as claimed in claim 15, further comprising:
reparing the temporary data stored in the random access memory by removing the malicious software if the malicious software is detected in the temporary data.

19. The malicious software prevention method as claimed in claim 15, further comprising:
quarantining the temporary data if the malicious software is detected in the temporary data.

20. The malicious software prevention method as claimed in claim 15, further comprising:
deleting the temporary data if the malicious software is detected in the temporary data.
